(19) United States
(12) Patent Application Publication
(10) Pub. No.: US 2014/0340756 A1
(43) Pub. Date: Nov. 20, 2014

(54) OPTICAL COHERENCE TOMOGRAPHY OPTICAL PROBE SYSTEMS AND METHODS TO REDUCE ARTIFACTS

(71) Applicant: NinePoint Medical, Inc., Cambridge, MA (US)

(72) Inventors: Matthew A. Sinclair, Stoneham, MA (US); Narissa Y. Chang, Somerville, MA (US); Eman Namati, Arlington, MA (US); Jim W. Moriarty, JR., Georgetown, MA (US); Michael Madden, Temple, NH (US)

(73) Assignee: NinePoint Medical, Inc., Cambridge, MA (US)

(21) Appl. No.: 14/264,630

(22) Filed: Apr. 29, 2014

Related U.S. Application Data
(60) Provisional application No. 61/824,492, filed on May 17, 2013.

(51) Int. Cl. G02B 27/00

(52) U.S. Cl. CPC G02B 27/0018
USPC 359/614; 359/601

(57) ABSTRACT

A system for reducing artifacts produced in images using an optical probe system is provided. The artifacts are reduced by reducing power of secondary beam paths produced by non-Fresnel reflections by at least one of absorption, scattering and rejection of the secondary beam paths.

### RELATED APPLICATIONS

This application claims priority to U.S. provisional patent application Ser. No. 61/824,492, filed May 17, 2013, entitled OPTICAL COHERENCE TOMOGRAPHY OPTICAL PROBE SYSTEMS AND METHODS TO REDUCE ARTIFACTS, the entire contents of which are herein incorporated by reference.

### BACKGROUND

The present disclosure generally relates to medical devices systems and methods for imaging in biomedical and other medical and non-medical applications, and more particularly, to optical probes and systems for Optical Coherence Tomography (OCT) imaging.

Various forms of imaging systems are used in healthcare to produce images of a patient. Often, an image of an internal cavity of a patient is required. These cavities can include areas of the digestive system and/or the respiratory system. Surgical incisions are also used to access internal cavities. When imaging tissue features of these systems, fiber optic endoscopy is often utilized.

One type of fiber optic endoscope is based on Optical Coherence Tomography (OCT) techniques. OCT provides structural information on tissue with high resolution. OCT can provide this information in real time and in a non-invasive manner. Many different lens types have been used to construct fiber optic endoscopes. These lenses include fiber lenses, ball lenses and GRadient INdex (GRIN) lenses. Lens materials can vary from glass to plastic to silicon. Light from a light source is focused through the lens and into the tissue. The tissue scatters the light and the light that is reflected back to the probe is received at a detector.

An optical probe must be specifically manufactured to conform to optical parameters required for a specific use. Esophageal imaging requires probes of specific design to properly image into surrounding tissue. Typical esophageal imaging systems include a prism to direct light off axis into the surrounding tissue.

The typical optical imaging system consists of an optical probe. A particular optical probe has a set characteristics used for specific image requirements. Such characteristics can include, for example, depth of field, polarization, resolution, visible imaging, etc.

Many such optical probes are contained within a needle or hypotube. The hypotube provides rigid structure to an otherwise flexible fiber optic probe assembly. The hypotube also provides a rigid component to attach a torque coil. This configuration permits insertion of the probe through tissue and into a cavity in question. Hypotubes have inner surfaces that can reflect, scatter and/or focus light which can cause artifacts to appear in resulting images. These artifacts interfere with the proper reading of the images.

This disclosure describes improvements over these prior art technologies.

### SUMMARY

Accordingly, systems and methods for reducing stray light in a fiber optic system are provided. Optical coherence tomography optical probe systems and methods to reduce artifacts are disclosed.

Accordingly, a system for reducing artifacts produced in images using an optical probe system is provided. The artifacts are reduced by reducing power of secondary beam paths produced by non-Fresnel reflections by at least one of absorption, scattering and rejection of the secondary beam paths.

Accordingly, a system for reducing stray light in a fiber optic system is provided. The system includes an enclosure for use with the fiber optic system; an optical component contained in the enclosure; and a medium positioned between the optical component and the enclosure, wherein the medium is configured to absorb and/or scatter stray light within the enclosure.

Accordingly, a system for reducing stray light in a fiber optic system is provided. The system includes a molded optical component having an air interface index of refraction selected to permit non-Fresnel reflections to pass through and out of the molded optical component.

Accordingly, a system for reducing stray light in a fiber optic system is provided. The system includes an enclosure for use with the fiber optic system; an optical component contained in the enclosure; and a medium positioned between the optical component and the enclosure, wherein the medium and the enclosure are configured to transmit stray light through the medium and enclosure.

Accordingly, a method for reducing artifacts produced in images using an optical probe imaging system is provided. The method includes reducing power of secondary beam paths produced by non-Fresnel reflections by at least one of absorption, scattering and rejection of the secondary beam paths.

### BRIEF DESCRIPTION OF THE DRAWINGS

The present disclosure will become more readily apparent from the specific description accompanied by the following drawings, in which:

FIG. 1 is a diagram illustrating an Optical Coherence Tomography (OCT) optical probe system;

FIG. 2 is a diagram illustrating various operating parameters of an optical probe;

FIG. 3 is a diagram illustrating a typical OCT optical probe system;

FIG. 4 is a diagram illustrating an artifact producing phenomenon in a typical OCT optical probe system;

FIG. 5 is a diagram illustrating an optical probe system according to a first embodiment of the present disclosure;

FIG. 6 is a diagram illustrating an optical probe system according to a first embodiment of the present disclosure;

FIG. 7 is a diagram illustrating an optical probe system according to a second embodiment of the present disclosure;

FIG. 8 is a diagram illustrating an optical probe system according to a second embodiment of the present disclosure;

FIG. 9 is a diagram illustrating an optical probe system according to a second embodiment of the present disclosure;

FIG. 10 is a diagram illustrating an optical probe system according to a third embodiment of the present disclosure;

FIG. 11 is a diagram illustrating an optical probe system according to a third embodiment of the present disclosure;

FIG. 12 is a Abbe-diagram illustrating sample materials for use in the present disclosure

FIG. 13 is a diagram illustrating hypotube reflection;

FIG. 14 is a diagram illustrating Fresnel reflection;

FIG. 15 is an alternate embodiment of an optical probe system according to a third embodiment of the present disclosure; and

FIG. 16 is another alternate embodiment of an optical probe system according to a third embodiment of the present disclosure.

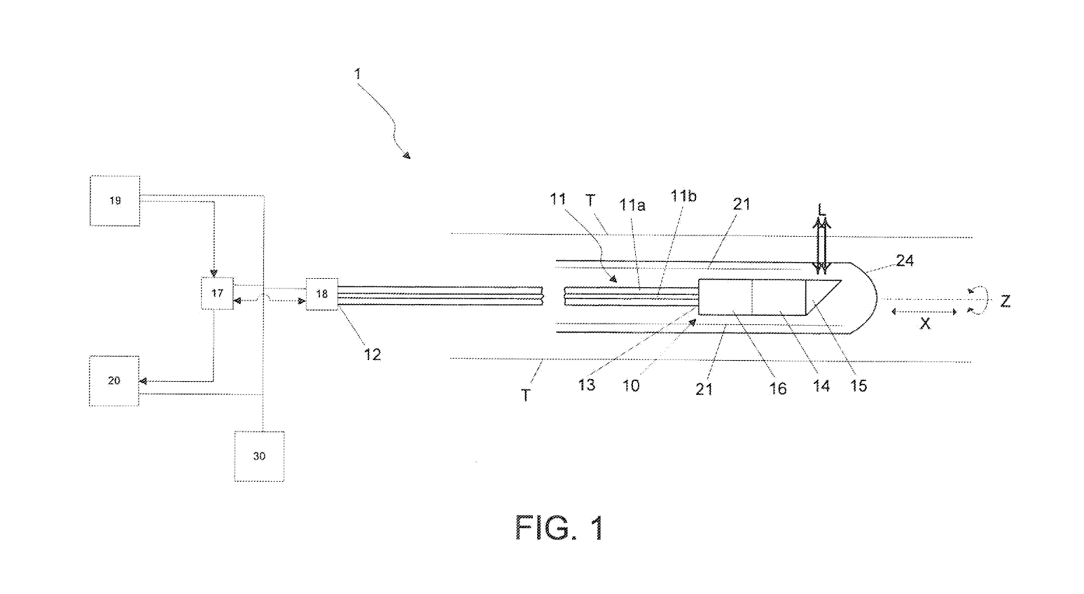

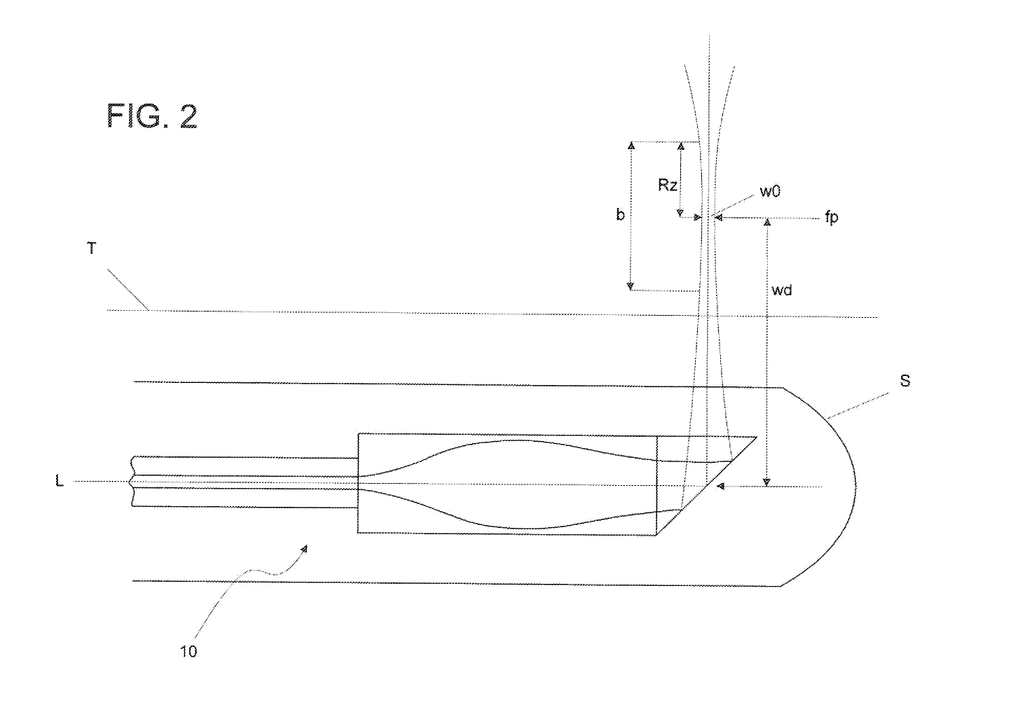

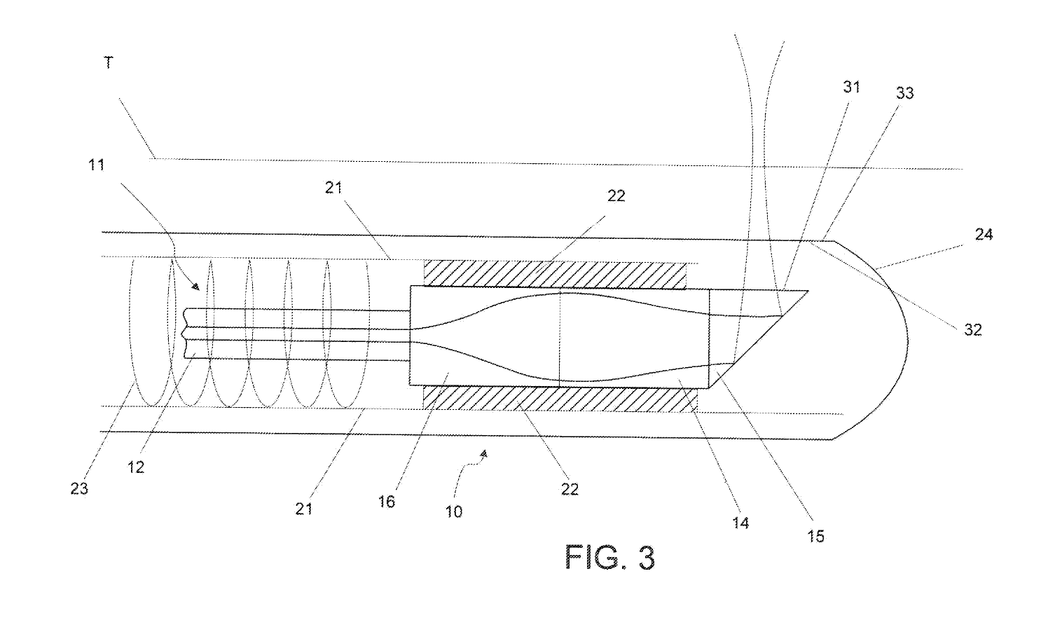

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right are for illustrative purposes only and can be varied within the scope of the disclosure.

A system for reducing stray light in a fiber optic system according to the present disclosure decreases the artifacts produced by scattered light reflecting and/or focusing off of surfaces of components used in the optical systems. Reference will now be made in detail to the exemplary embodiments of the present disclosure, which are illustrated in the accompanying figures.

An imaging system 1 using a catheter or an OCT probe 10 for an endoscope is comprised of an optical fiber 11 having a casing 11a, a fiber core 11b, a proximal end 12 and a distal end 13, a spacer 16 connected to the distal end of the optical fiber 11, a GRIN lens 14 connected to spacer 16, and a prism 15 connected to GRIN lens 14 and configured to deflect light into surrounding tissue T. Spacer 16 is positioned before the GRIN lens to modify the optical parameters. The fiber core 11b, GRIN lens 14, prism 15, and spacer 16 are typically connected by fusing the components together or using an optical-grade epoxy to glue the components together.

A GRIN lens is described herein for illustrative purposes. Other lenses and lens structures are contemplated. For example, ball lenses, fiber optic lenses, and molded lenses (all of these may be made with or without a grating) can be utilized as the probe without departing from the scope of the present invention.

Probe 10 can be contained within a lumen 24. Lumen 24 containing probe 10 is inserted into a cavity of a patient to image into tissue T surrounding probe 10. Lumen 24 protects probe 10 and tissue T from damage. In addition, hypotube 21 is positioned about probe 10 and within lumen 24. Hypotube 21 provides a rigid structure to the probe 10 and fiber 11 assembly, as well as protects probe 10 and provides a rigid structure to attach a torque coil.

Probe 10 is typically connected to a coherent light source 19 at proximal end 12 of optical fiber 11 through a rotary junction 18 and optical components 17. Also included is a detector 20 to detect light reflected back from tissue T. The optical components 17 can include elements to direct light from light source 19 toward probe 10 and elements to direct light from probe 10 to detector 20.

System 1 is shown connected to computer 30. Computer 30 provides control for the components of system 1. Computer 30 also provides image processing functions to produce images from light detected at detector 20. Computer 30 can include one or more input devices such as a keyboard and/or a mouse (not shown). Computer 30 can also include one or more output devices such as a display (not shown) for displaying, for example, instructions and/or images.

In operation, light L travels from light source 19, through optical components 17, rotary junction 18, optical fiber 11, spacer 16, lens 14 and prism 15 and into tissue T. Light L is reflected back from tissue T, through prism 15, lens 14, spacer 16 and optical fiber 11, and is directed by optical components 17 to detector 20.

In order to provide an image of a particular area of tissue T, probe 10 is translated along direction X and rotated about axis Z. This translation and rotation directs light L into tissue T at an area of concern. In order to produce a complete radial scan of tissue T surrounding probe 10, probe 10 must be rotated 360 degrees to produce an image of a first slice of tissue T and then translated along direction X to produce an image of an adjacent slice of tissue T. This rotation/translation process continues along direction X until the area of concern of tissue T is completely scanned.

To ensure proper imaging into tissue using an OCT probe required strict compliance to probe specifications in order to precisely set the optical parameters. These parameters can include the Rayleigh Range Rz, the confocal parameter b, the waist w0, the focal point fp, and the working distance wd. The term “beam waist” or “waist” as used herein refers to a location along a beam where the beam radius is a local minimum and where the wavefront of the beam is planar over a substantial length (i.e., a confocal length). The term “working distance” as used herein means the distance between the optical axis aligned with the fiber and the focal point fp.

An optical probe must be specifically manufactured to conform to required optical parameters. Esophageal imaging requires probes of specific design to properly image into surrounding tissue T. When using an optical probe for esophageal imaging, a long working distance with large confocal parameter is required. Generally in esophageal imaging the working distances from the center of the optical probe radially outward to the tissue ranges from 6 mm to 12.5 mm. The optic itself can be 1 mm in diameter, with a protective cover (not shown) in sheath S and with a balloon (not shown) on top, while still fitting through a 2.8 mm channel in an endoscope. With no tight turns required during the imaging of the esophagus (compared, for example, to the biliary system, digestive system or circulatory system), an optical probe can be as long as 13 mm in length without a interfering with surrounding tissue T. In attempts to manufacture an optical probe that conforms to these parameters, several designs have been utilized. Ball lenses, GRadient INdex (GRIN) lenses, and molded lenses may be used with or without an outer balloon structure can increase the working distance and achieve better imaging conditions.

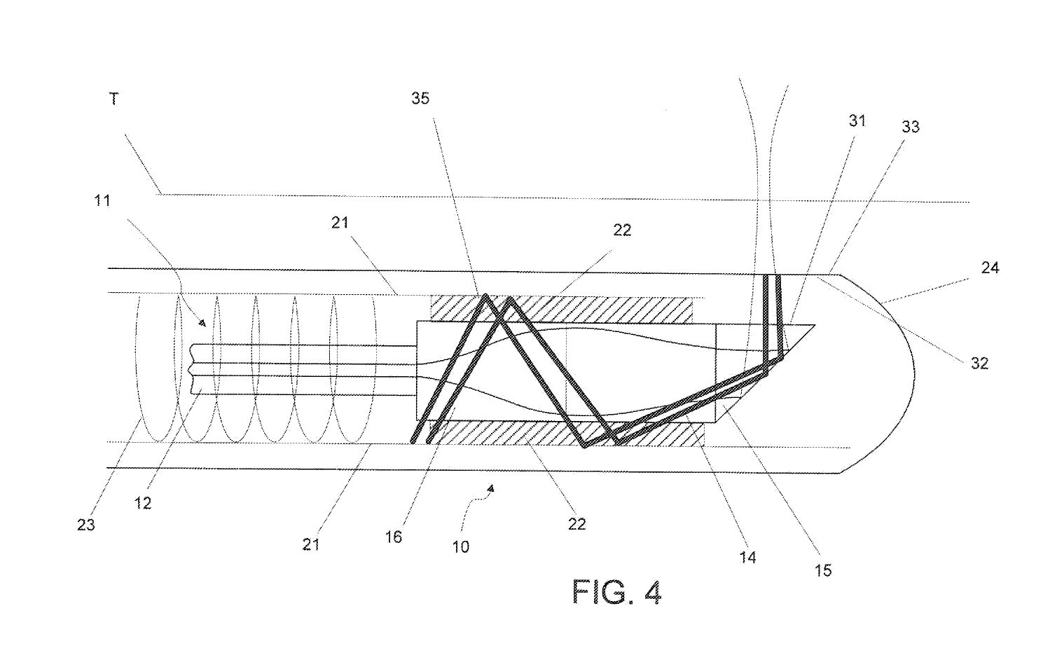

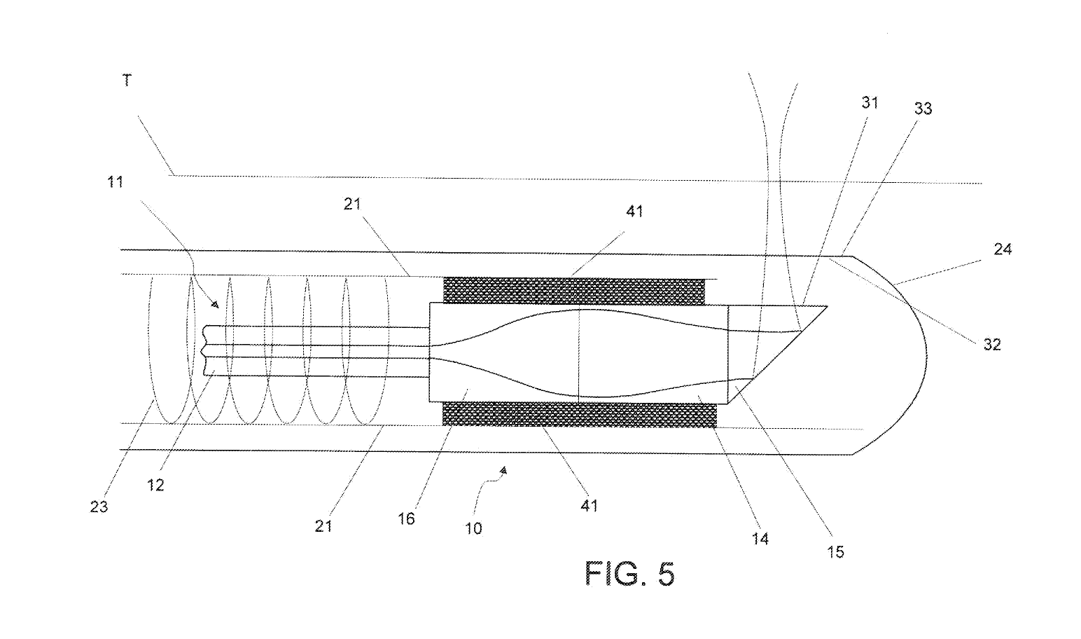

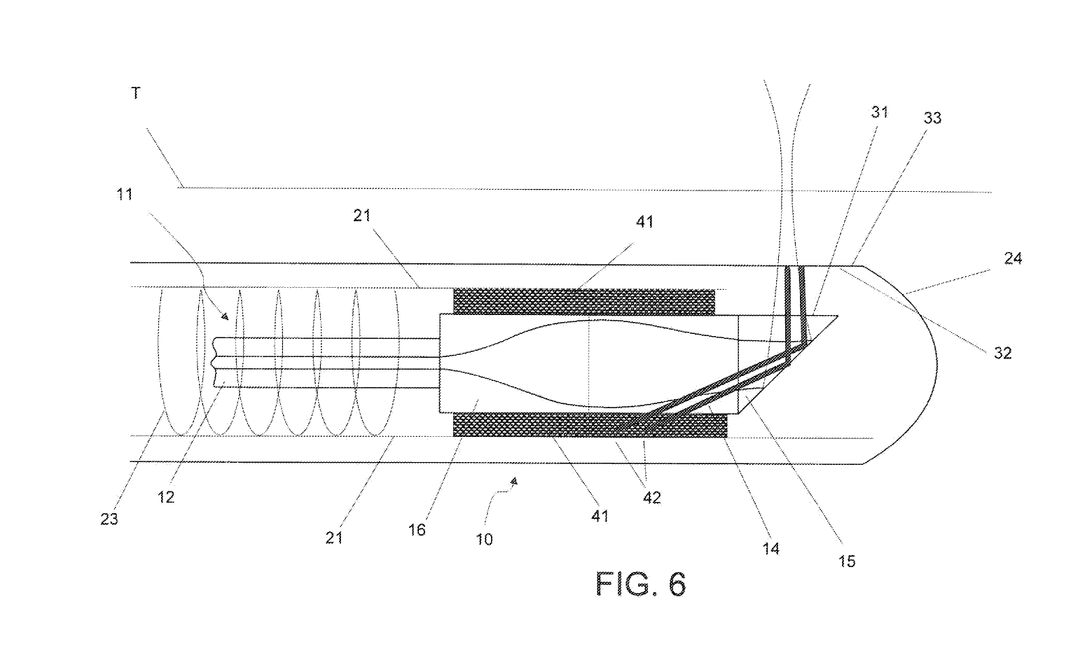

FIG. 4 illustrates a typical OCT probe system. Probe 10 is shown attached to fiber optic 11. A torque coil 23 is shown positioned within hypotube 21. Torque coil 23 is attached to hypotube 21 to provide stress and strain free rotation to probe 10 during rotation and translation. Also show in adhesive 22 used to attach probe 10 to hypotube 21.

OCT imaging can have a single or multiple apertures where the illuminating source and detected light use the same aperture. This creates a problem since light always reflects directly back along the path from where it came with significantly more power than is scattered to the side. This means a single beam coming out of the optical probe may take multiple paths which all make it back to the detector if the beam is split into multiple beam paths. The prism can reflect light back into the optical probe, the inner lumen inner diameter, and the inner lumen outer diameter. These multiple reflections create multiple non-controlled beam paths. These particular paths currently go back into the optical probe fixed in a protective hypotube. The protective hypotube creates a positive mirror internally for the reflected light passing it from one side of the hypotube to the other creating multiple foci. When the waist falls close to a surface, object, and/or defect, a more intense signal propagates back to the optical fiber creating an artifact.

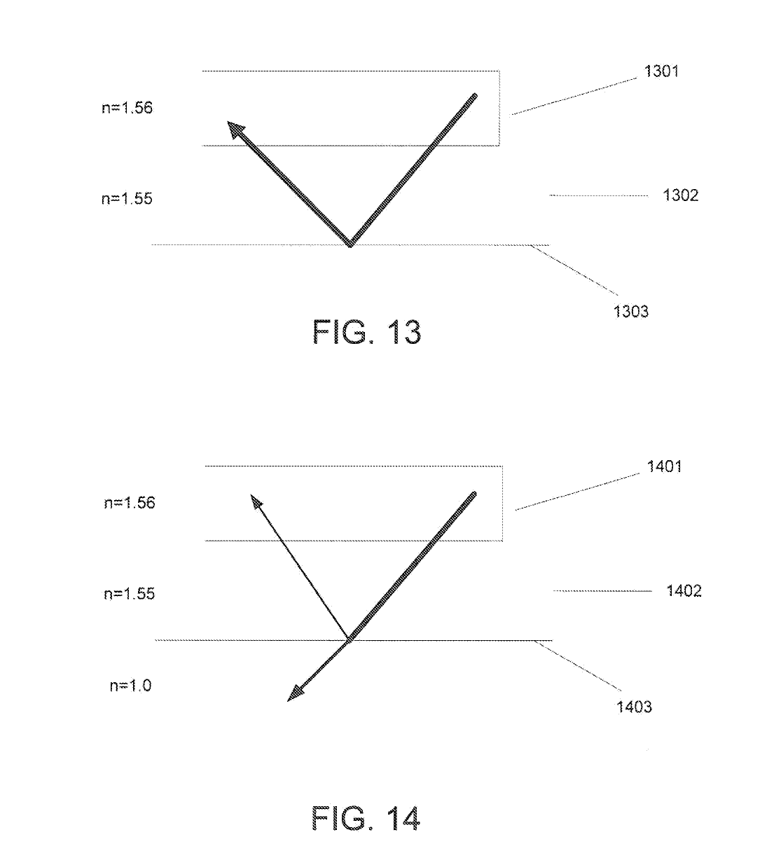

In FIG. 13, steel hypotube 1303 will reflect nearly 100% of the light that passes through GRIN lens 1301 (index of refraction n=1.56) and adhesive 1302 (n=1.55) due to its high reflectivity. In FIG. 14, other materials for the hypotube 1403 (e.g. Lexan) will produce Fresnel reflections of the light that passes through GRIN lens 1401 (index of refraction n=1.56) and adhesive 1402 (n=1.55) and into air (n=1.0) based on

$$reflection = {( \frac{n 2 - n 1}{n 2 + n 1} )}^{2} .$$

The three surfaces with high Fresnel reflections are surface of prism 31, inside surface 32 of lumen 24 and outside surface 33 of lumen 24. In prior art systems, adhesive 22 is optically transmissive. This allows light to transmit through adhesive 22 and onto the inner walls of hypotube 22. The inner walls of hypotube 22 act as powerful mirrors constantly refocusing the secondary beam path 35 with almost no power loss between reflections. Eventually, these reflections create a waist on a surface causing high back reflections, which produce artifacts on the resulting image. By preventing these reflections inside the hypotube, less artifacts will be present in the final image.

This present disclosure reduces and/or eliminates the multiple beam paths by scattering, absorbing, and/or releasing the power from the optical probe.

A first system to reduce and/or eliminate the multiple beam paths in accordance with the present disclosure is achieved by introducing a medium to scatter and absorb the stray power from the optical probe. In one embodiment of the present disclosure, introducing an absorbing and/or scattering adhesive 41 to bond the optical probe will reduce and/or eliminate the artifacts by absorbing the reflection 42. An adhesive 41 such as EpoTek 353N0-Black or EpoTek 320 (for Near InfraRed (NIR) wavelengths), produced by Epoxy Technology, Inc can be used.

A key feature when selecting an adhesive is making sure the index of refraction is close to, if not greater than, the index of refraction of the optical probe itself. An index of refraction approximately equal to the optical probe index of refraction will have minimum Fresnel reflection while allowing the light to be absorbed into the opaque material. An adhesive with an index of refraction greater than the index of refraction of the optical probe can pull the light out of the optical probe and make it difficult for the light to re-enter. Reflected light 42 is absorbed/scattered thus producing no back reflection to cause artifacts.

A second system to reduce and/or eliminate the multiple beam paths in accordance with the present disclosure is achieved by removing the hypotube altogether, thus removing the high reflector of the inner surface. As discussed above, hypotube 21 behaves as a high reflector since it is a continuous highly reflective positive mirror. The purpose of the hypotube in current optical systems is to protect optical probe 10 and provide a surface to attach torque coil 23. Thus, the second system focuses on providing lens protection and attaching a torque coil without the need of a hypotube.

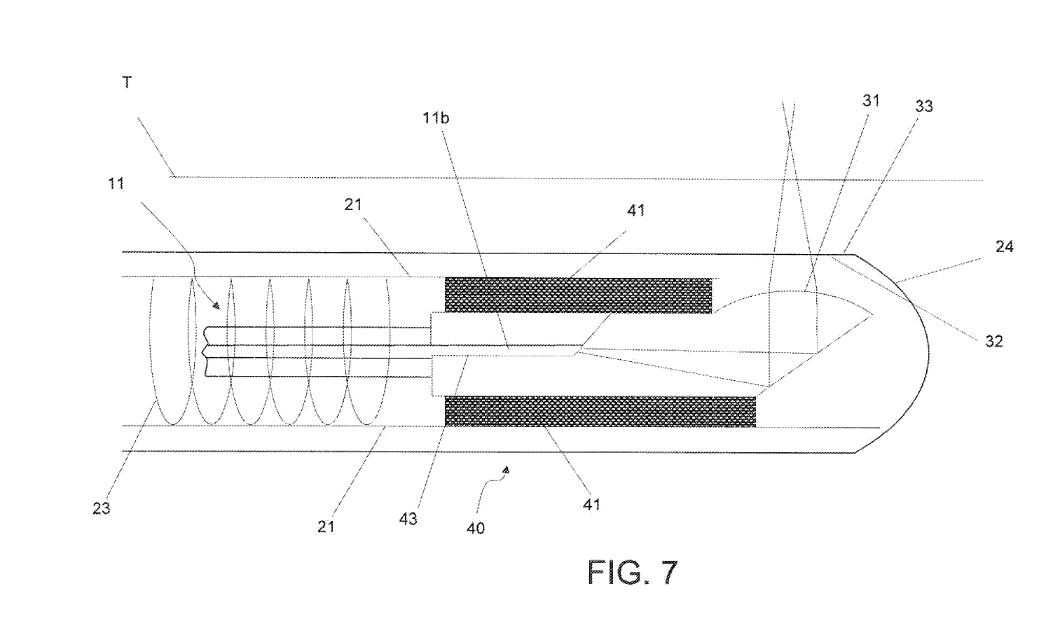

One type of optical probe is a molded optical probe, for example as disclosed in U.S. Provisional Application No. 61/696,616 entitled Low Cost Molded Optical Probe, the entire contents of which are incorporated herein by reference. The molded probe 40 can be affixed in hypotube 21 with adhesive 41 as shown in FIG. 7, similar to the system disclosed above in accordance with the present disclosure. Fiber optic core 11b is affixed into a groove 43 molded into probe 40.

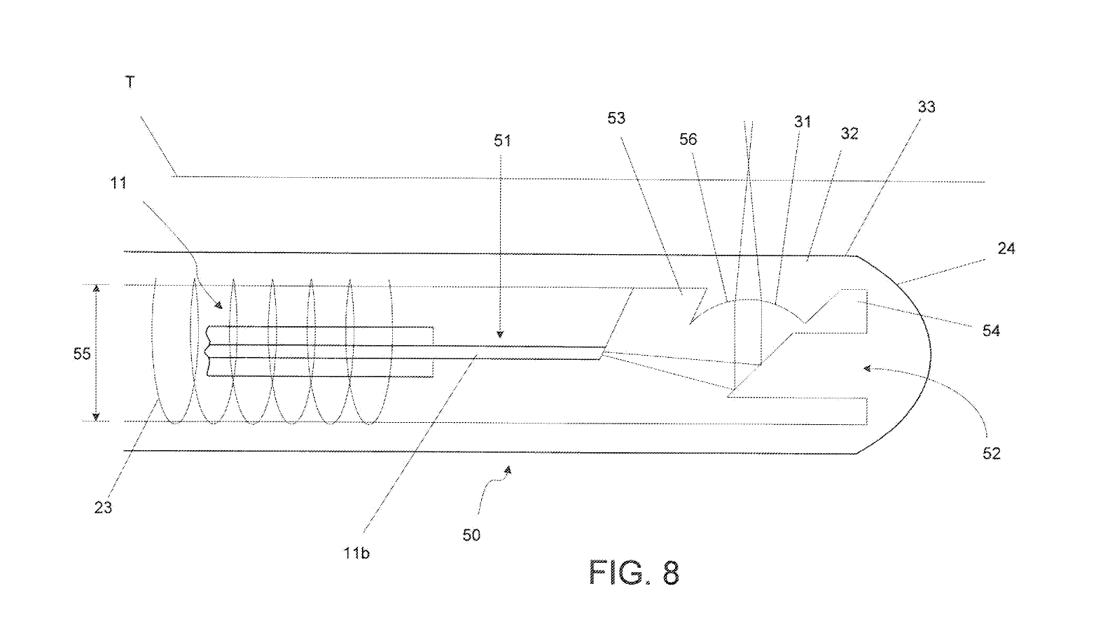

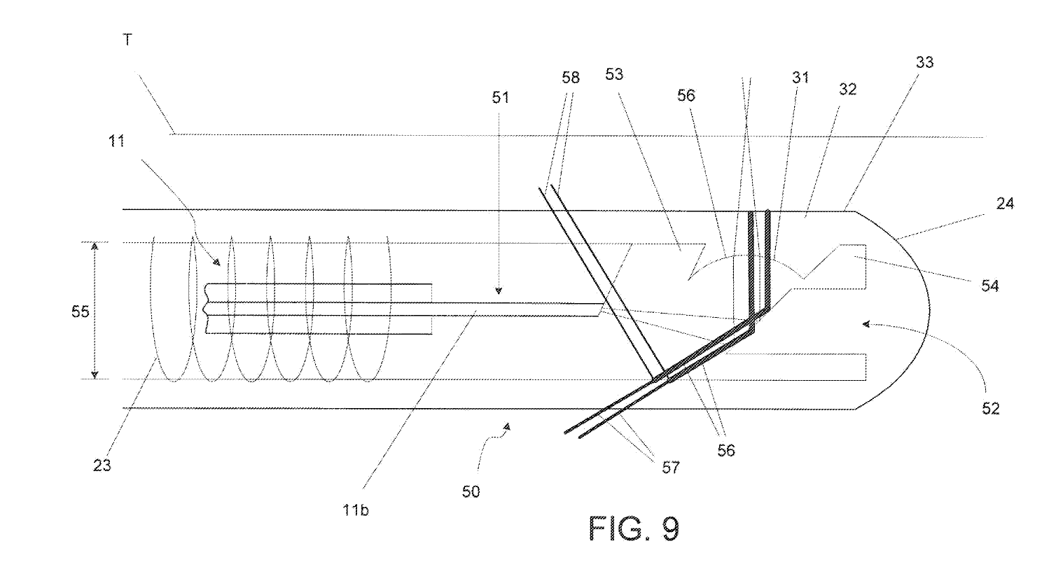

In the second embodiment illustrated in FIG. 8, optical probe 50 can be molded larger in diameter 55 and as a single unit. Probe 50 can include molded lens protectors 53 and 54 to protect the optical window 56 (i.e. lens) and have a connection for torque coil 23. This configuration will allow for the removal of the hypotube from the system. Torque coil 23 can be directly bonded to probe 50; other affixing methods are contemplated. Probe 50 defines a deep groove 51 (preferably positioned from the top of and down into probe 50) for receiving and affixing therein fiber optic core 11b. Probe 50 also defines a hollow section 52 for placement of an optical mirror (not shown).

The multiple light paths (56/57/58) reflected back into the optical probe 50 would have less power to create artifacts since only Fresnel reflections would continue to propagate. That is, as the artifact producing light 56 propagates along probe 50, part of the light 57 is permitted to escape from the probe 50, and with each internal reflection eventually all of the remaining unwanted light 58 is released from probe 50.

Probe 50 can be manufactured as a molded design or a glass design. Some examples of materials for molded optics are as follows: Acrylonitrile Butadiene Styrene (ABS), Cyclic Polyolefins (Zeonor and Zeonex), Nylon, Polycarbonate (Lexan 1130, Lexan HPS26, Makrolon 3158, Makrolon 2458), Polyether Imide (Ultem 1010), Polymethyl methacrylate, Polyethersulfones (RTP 1400), Polystyrene, Silicone, TPE/TPU. Other materials are contemplated.

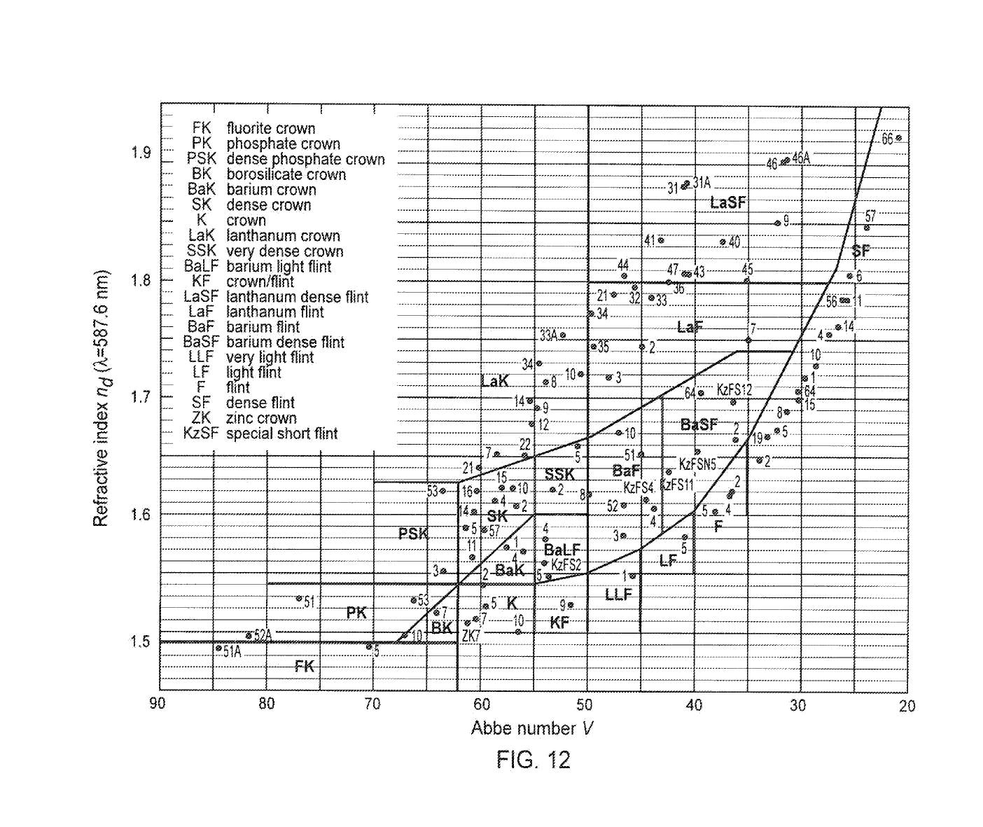

There are many different glasses used in the manufacture of optics that can be used to manufacture a glass hypotube. Many glasses are used to make glass tubes. See, e.g. FIG. 12. For use with the present disclosure, a glass with an index of refraction greater than or equal to the index of refraction of the GRIN lens (i.e., n=1.56) works best. A glass with an index of refraction below 1.56 will work, but with less efficiency.

A third system to reduce and/or eliminate the multiple beam paths in accordance with the present disclosure is achieved by permitting light to transmit out of the hypotube itself. As discussed above, hypotube 21 behaves as a high reflector since it is a continuous highly reflective positive mirror.

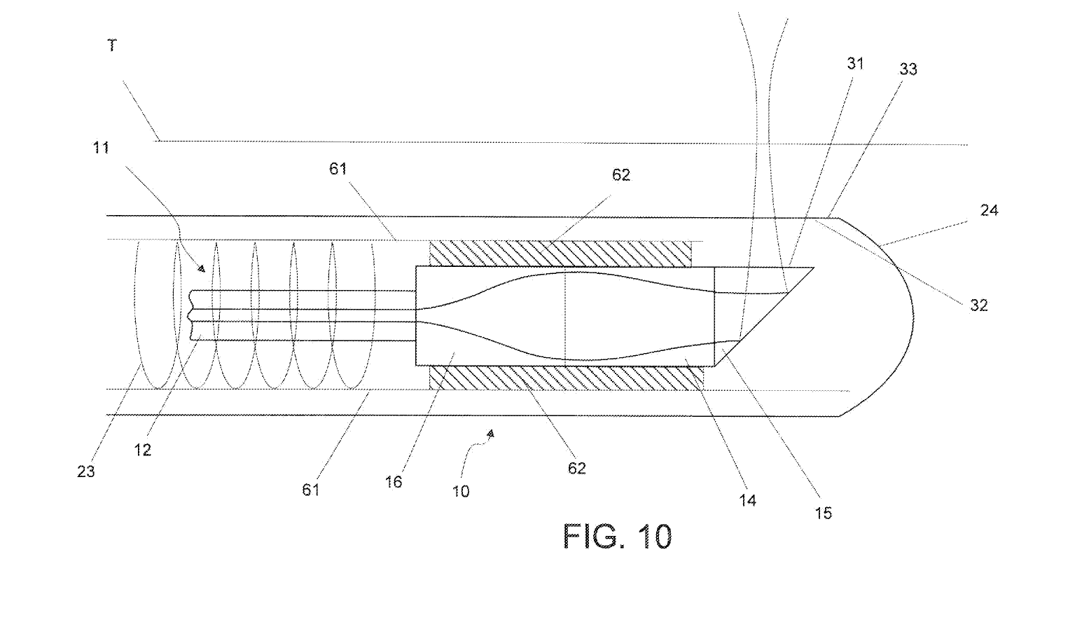

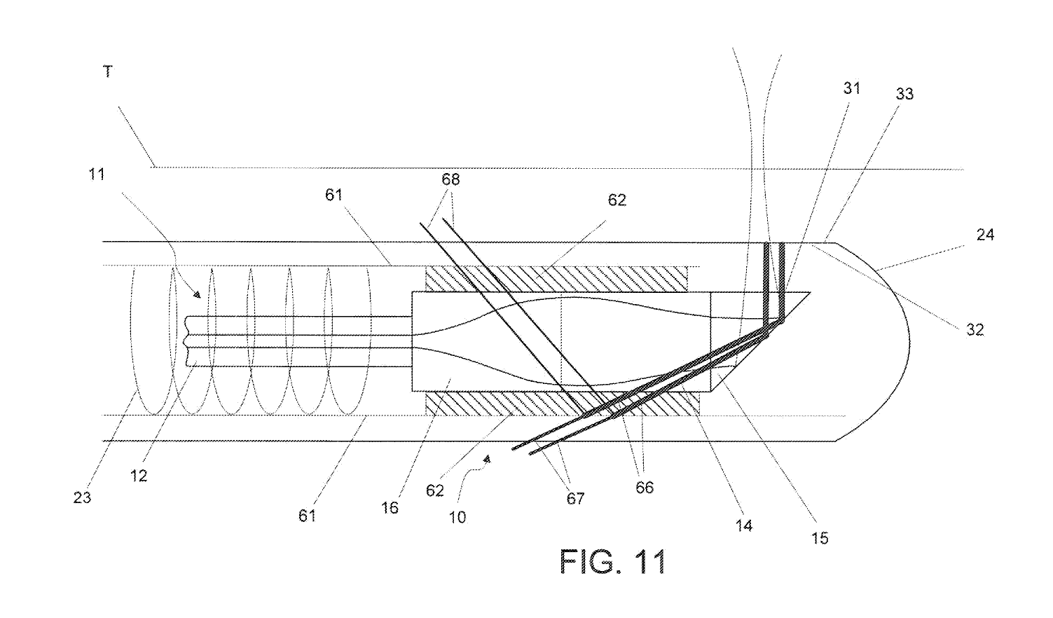

In a third embodiment as illustrated in FIG. 10 a metallic hypotube is replaced with a hypotube 61 manufactured from a light transmissive material to permit the light to pass out of the optical probe system. In addition, the adhesive 62 used in the third embodiment can be selected to permit release of as much stray light as possible. This would be similar to the second method where only Fresnel reflections would continue to propagate. The index of refraction of the material used to manufacture hypotube 61 could be significantly greater than the index of refraction of optical probe 10, thus preventing light from re-entering optical probe 10.

The multiple light paths (66/67/68) reflected back into the optical probe 10 would have less power to create artifacts since only Fresnel reflections would continue to propagate. That is, as the artifact producing light 66 propagates along probe 10, part of the light 67 is permitted to escape from the probe 10, and with each internal reflection eventually all of the remaining unwanted light 68 is released form probe 10.

Probe 50 can be manufactured as a molded design or a glass design. Some examples of materials for molded optics are as follows: Acrylonitrile Butadiene Styrene (ABS), Cyclic Polyolefins (Zeonor and Zeonex), Nylon, Polycarbonate (Lexan 1130, Lexan HPS26, Makrolon 3158, Makrolon 2458), Polyether Imide (Ultem 1010), Polymethyl methacrylate, Polyethersulfones (RTP 1400), Polystyrene, Silicone, TPETTPU. Other materials are contemplated.

As stated above, there are many different glasses used in the manufacture of optics that can be used to manufacture a glass hypotube. Many glasses are used to make glass tubes. See, e.g. FIG. 12. For use with the present disclosure, a glass with an index of refraction greater than or equal to the index of refraction of the GRIN lens (i.e. n=1.56) works best. A glass with an index of refraction below 1.56 will work, but with less efficiency.

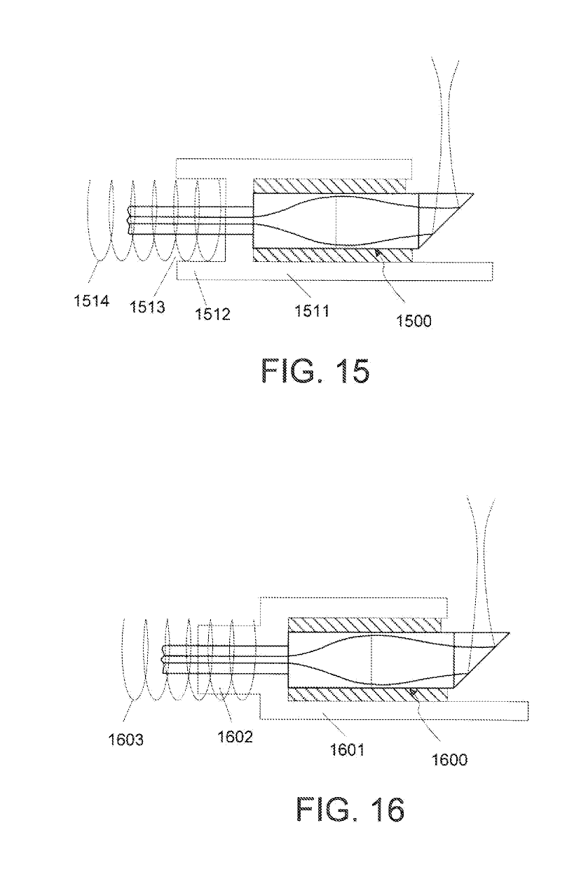

FIGS. 15 and 16 are configurations of glass hypotubes designed to allow a torque coil to directly attach to the optical probe.

FIG. 15 shows optical probe 1500 and glass hypotube 1511. Hypotube 1511 has a collar 1512 that defines an indent 1513. Indent 1513 can accept torque coil 1514, which can be attached therein.

FIG. 16 shows optical probe 1600 and glass hypotube 1601. Hypotube 1601 has a step 1602. Step 1602 can accept torque coil 1603 there around. Torque coil 1603 can be attached to step 1602.

Overall, reducing the power in secondary beam paths by absorption, scattering, or rejection would reduce or eliminate artifacts in images from an optical probe. The mechanisms of “scattered” light is novel in its application for optical coherence tomography probe, spectroscopy probe, confocal probe, fluorescence probe and any device which shares a detection aperture with an illumination source. The systems and methods of the present disclosure can reduce and/or eliminate the stray light of non-Fresnel reflections and in doing so reduce and/or eliminate artifacts in resulting images.

The present disclosure has been described herein in connection with an optical imaging system including an OCT probe. Other applications are contemplated. For example, fiber optic communication systems use connectors and other metallic components with inner reflective surfaces. These inner surfaces often create stray light impulses in neighboring light paths or fiber optics. This produces a cross-over or cross-talk of information (voice and/or data) from one light path or one optical fiber to another. By applying the disclosed invention to these communication systems, these problems can be eliminated.

Where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A system for reducing artifacts produced in images using an optical probe system, comprising means for reducing power of secondary beam paths produced by non-Fresnel reflections by at least one of absorption, scattering and rejection of the secondary beam paths.

2. The system of claim 1, wherein the system includes an enclosure and an optical component contained in the enclosure, and the means for reducing power of the secondary beam paths includes a medium positioned between the optical component and the enclosure, and
wherein the medium is configured to absorb and/or scatter stray light within the enclosure,

3. The system of claim 1, wherein the system includes a molded optical component having an air interface index of refraction selected to permit non-Fresnel reflections to pass through and out of the molded optical component.

4. The system of claim 1, wherein the system includes an optical component, and the means for reducing power of the secondary beam paths includes a transparent enclosure configured to contain the optical component and a medium positioned between the optical component and the enclosure, and
wherein the medium and the enclosure are configured to transmit stray light through the medium and enclosure.

5. A system for reducing stray light in a fiber optic system, comprising:
an enclosure for use with the fiber optic system;
an optical component contained in the enclosure; and
a medium positioned between the optical component and the enclosure,
wherein the medium is configured to absorb and/or scatter stray light within the enclosure.

6. The system of claim 5, wherein the medium is an adhesive configured to affix the optical component within the enclosure.

7. The system of claim 6, wherein an index of refraction of the medium is approximately equal to or greater than an index of refraction of the optical component.

8. The system of claim 6, wherein the enclosure is a rigid and non-transparent structure configured to rotate the optical component.

9. The system of claim 5, wherein the fiber optic system is an Optical Coherence Tomography (OCT) system for imaging tissue.

10. A system for reducing stray light in a fiber optic system, comprising;
a molded optical component having an air interface index of refraction selected to permit non-Fresnel reflections to pass through and out of the molded optical component.

11. The system of claim 10, wherein the molded optical component includes a GRIN lens having an index of refraction approximately equal to or less than an index of refraction of the molded optical component.

12. A system for reducing stray light in a fiber optic system, comprising:
an enclosure for use with the fiber optic system;
an optical component contained in the enclosure; and
a medium positioned between the optical component and the enclosure,
wherein the medium and the enclosure are configured to transmit stray light through the medium and enclosure.

13. The system of claim 12, wherein the medium is an adhesive configured to affix the optical component within the enclosure.

14. The system of claim 13, wherein an index of refraction of the enclosure is greater than an index of refraction of the optical component.

15. The system of claim 13, wherein the enclosure is a rigid and non-transparent structure configured to rotate the optical component.

16. The system of claim 12, wherein the fiber optic system is an Optical Coherence Tomography (OCT) system for imaging tissue.

17. The system of claim 12, wherein the optical component includes a GRIN lens having an index of refraction approximately equal to or less than an index of refraction of the enclosure.

18. A method for reducing artifacts produced in images using an optical probe imaging system, comprising the steps of:
reducing power of secondary beam paths produced by non-Fresnel reflections by at least one of absorption, scattering and rejection of the secondary beam paths.
